(19) United States
(12) Patent Application Publication
(10) Pub. No.: US 2003/0168289 A1
(43) Pub. Date: Sep. 11, 2003

(54) Device for transporting people by a spreader

(76) Inventor: Heide Faller, Ergoldsbach (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/363,378

(22) PCT Filed: Aug. 27, 2001
(86) PCT No.: PCT/EP01/09862

(30) Foreign Application Priority Data
Aug. 27, 2000 (DE) 100 41 932.1

(51) Int. Cl. B66B 5/16

(52) U.S. Cl. 187/359

(57) ABSTRACT

An apparatus for transporting people by a spreader having a vertically moveable head beam with a pair of horizontally extendable long bars includes a pair of personnel cages carried by a pair of cantilever beams extending from a housing. The personnel cages can be mounted to free ends of the long bars and be moved vertically with respect to the spreader.

The invention relates to a device for transporting people by a spreader as set forth in the preamble of claim 1.

When unloading containers transported on ships, at first the containers have to be unshipped which are positioned on the hatch covers. In order to protect them against falling off during the journey the containers are locked against each other and relative to the hatch covers by means of so-called “twistlocks” (interlocking elements to be provided at the corners of the containers). Prior to the unloading procedure, said twistlocks have to be unlocked manually. In the case of twistlocks which must be handled completely manually, they are put first, also for the loading procedure, on the hatch cover or on the containers already loaded, whereupon they are also manually interlocked. As the containers are often stacked up to five layers on the hatch covers, it is extremely difficult to reach them from the deck or from the gangways between the container stacks. The lower two layers are locked or unlocked by rods from the deck or the gangway, whereas the upper layers have to be unlocked from above, using the afore mentioned rods. As in many cases salient containers hinder accessibility, the before mentioned operations are extremely dangerous and often result in fatal accidents. This is why in many States legal provisions have been issued generally prohibiting any operation from the upper surface of the containers. However, said provisions cannot be followed in practice because, up to now, suitable devices are missing which could safely transport the staff on the spot to open the twistlocks.

In view of these problems various producers are trying to find a solution and offer appropriate devices. Said devices (so-called personnel cages) are used to transport the staff as near as possible to their point of intervention. Personal cages are known which—when hanging under the spreader—are positioned on the uppermost container. From here, the staff operates using the already mentioned rods. In a further known device, two cages occupied by operators and also hanging underneath the spreader, hang down along the front parts of the containers, such that they make it possible to safely reach at least the twistlocks of the uppermost layer. A further known device facilitates, by means of three personnel cages interconnected through ladders, the locking and unlocking of the three uppermost layers. However, this device, due to its overall height, is only fit for limited use (necessary hoisting height and salient containers). A further important requirement to facilitate an efficient routine of loading and unloading is the necessity to mount said device directly on the bridge crane use for ship loading. Due to the specific construction of these very expensive bulk devices there is no place suitable for such a device.

It is an object of the invention to provide a device which may be simply picked up by the spreader, which has overall dimensions facilitating the mounting on the bridge crane and from which it would be possible to lock and unlock at least two to four layers of containers.

This problem is resolved by the characterizing part of claim 1. Further advantageous features are set forth in the dependent claims. A preferred embodiment of the invention will now be described as illustrated in the drawings in which:

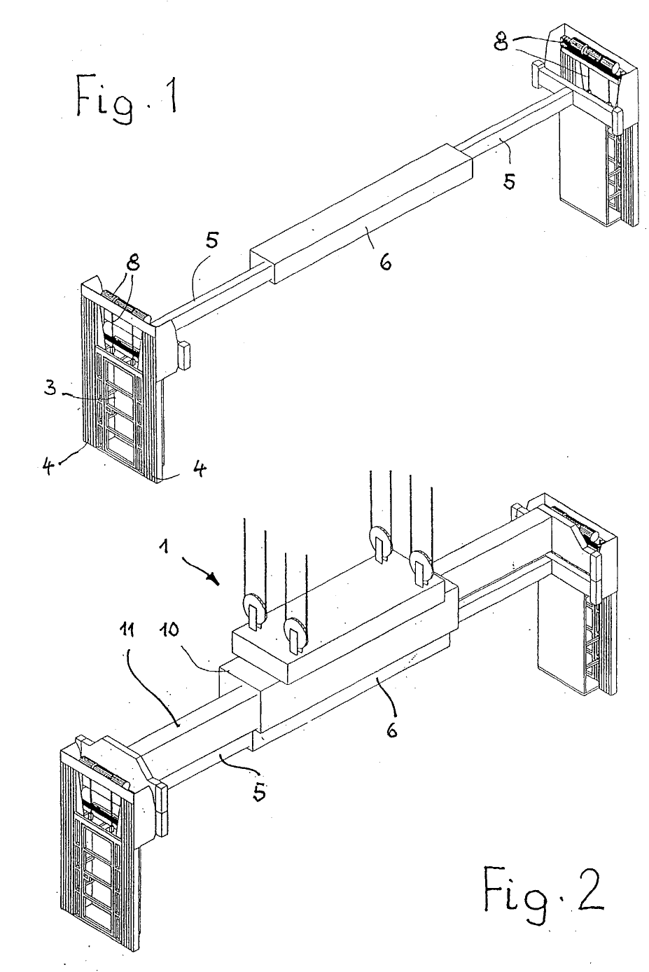

FIG. 1 is a perspective view of the device, as a whole called “personnel cage”,

FIG. 2 is a perspective view of the personnel cage picked up from the spreader,

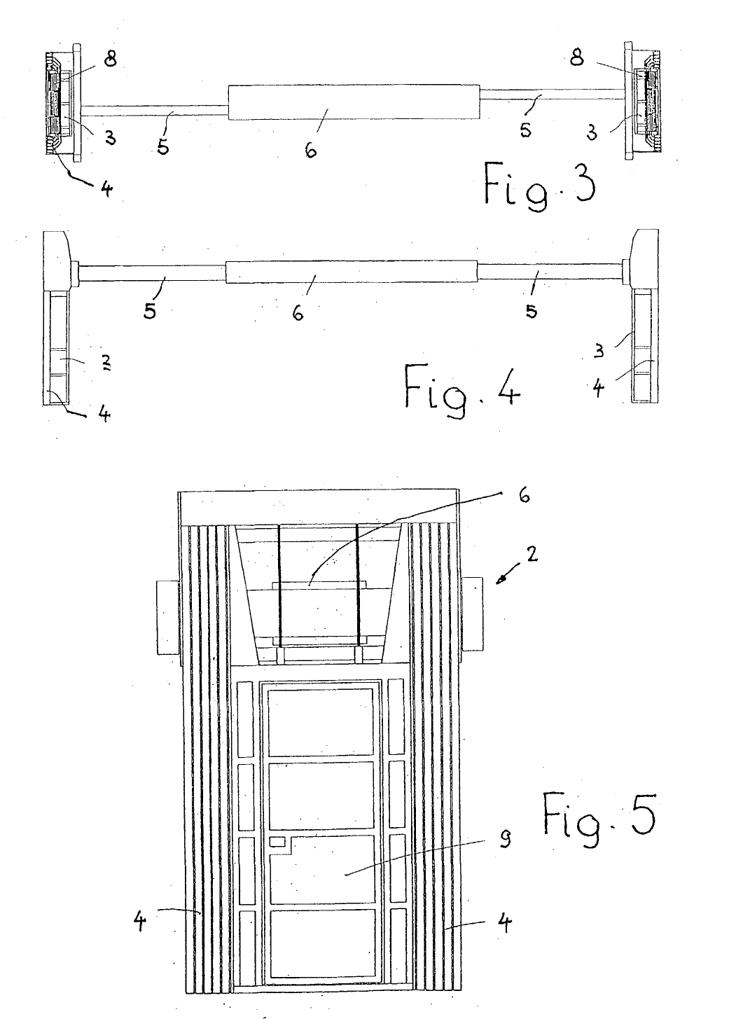

FIG. 3 is a top view of the entire personnel cage,

FIG. 4 is a front view of the personnel cage,

FIG. 5 is a lateral view of the personnel cage,

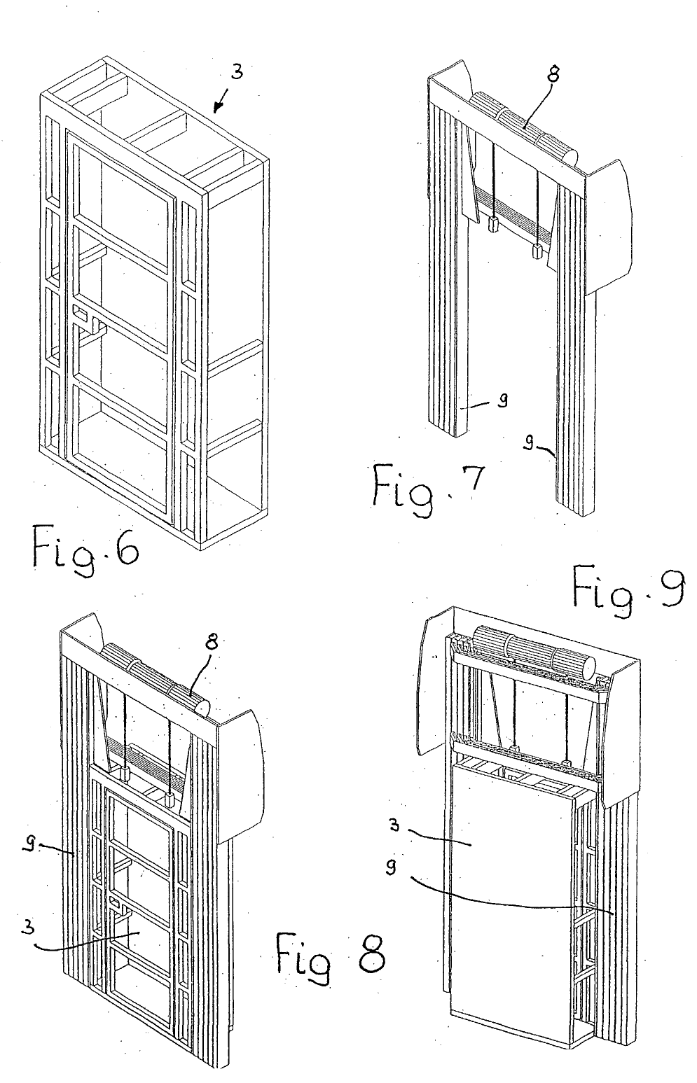

FIG. 6 is a perspective view of the personnel cage from the side of the door,

FIG. 7 is a perspective view of the telescopic bars of the personnel cage,

FIG. 8 is a perspective view of the personnel cage with its bars from the side of the door,

FIG. 9 is a perspective view of the personnel cage with its bars from the side facing the container,

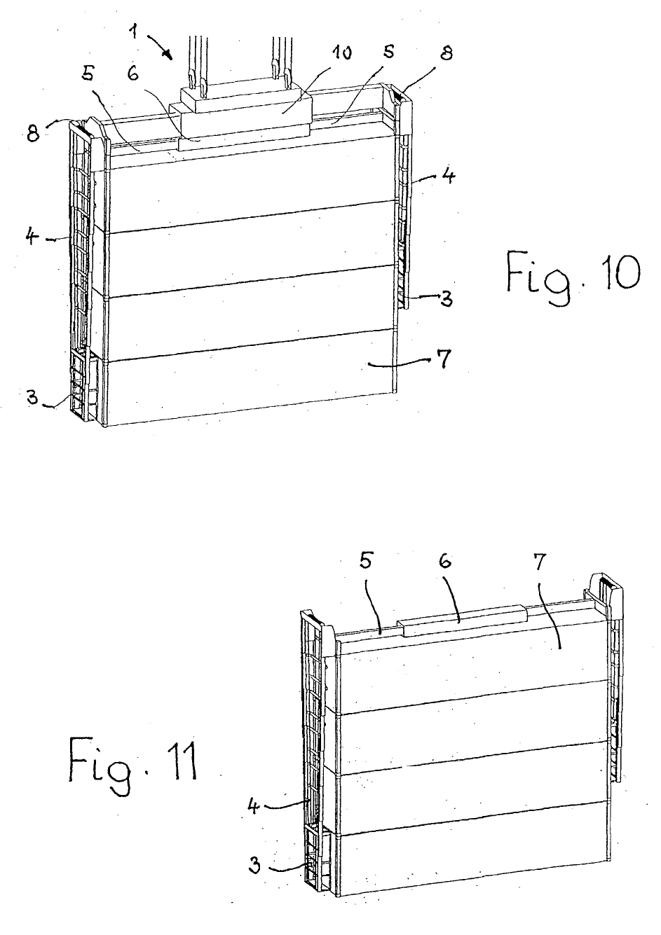

FIG. 10 is a perspective view of the entire personnel cage picked up from the spreader positioned on a stack of containers, being in a vertically telescopic extended working position,

FIG. 11 is a perspective view of the entire personnel cage without spreader, in its position on the top of a container stack and in a vertically telescopic extended working position,

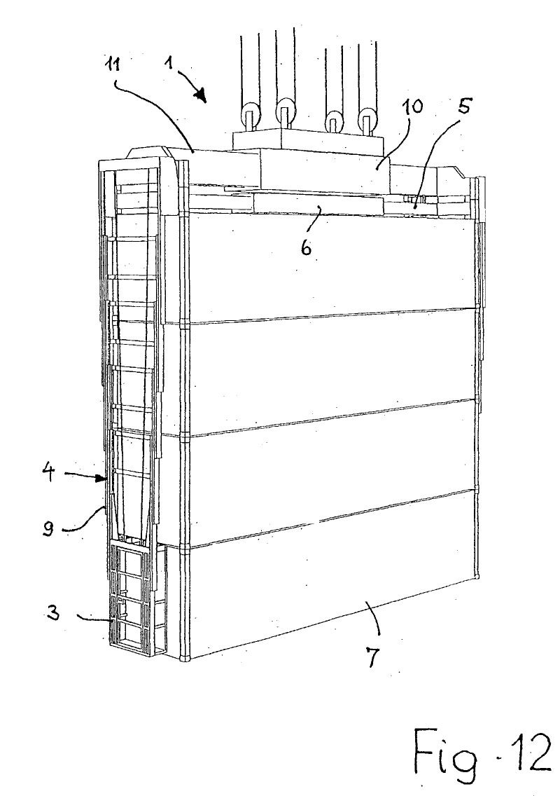

FIG. 12 is a view similar to that of FIG. 10.

As illustrated in the drawing it is provided that a spreader 1 is suited to pick up a carrier 2 to which are fastened, at both ends, two personnel cages 3 used to carry operators. Each of said personnel cages 3 may be extended downward by means of a vertical telescoping frame 4 to such a position that all layers of containers 7 may be easily reached. The personnel cage 3 offers to the transported operators sufficient protection not only during the entering phase between the container stacks but also during vertical movement.

The entire device comprises an upper carrier 2 which is preferably constructed in such a way that it may be automatically picked up by the spreader 1 without the need of any modification. Obviously, other embodiments may also be used allowing the fixing of the carrier 2 to the head beam 10 of the spreader 1 manually by means of a separate pick up device or also automatically.

As shown in FIG. 1, both personnel cages 3 are fastend to a cantilever beam 5 telescopically mounted in a housing 6. The horizonal propulsion for extending and retracting the cantilever beams 5 is effected by the corresponding movement of the spreader 1. In this way it is possible that, in the case of shifting above long containers, it is not necessary to transport the entire personnel cage over the top of said containers, but it is sufficient to move it in the same vertical position without any need to lift it, simply relocating it relative to the front faces in a transverse direction. This has the advantage that in the case of several long containers 7, positioned one adjacent to the other, the twistlocks can also be opened or locked which are positioned at the bottom.

On both cantilever beams 5 vertically telescoping frames 4 are fastened enabling the personnel cage 3 to be lowered to such an extent that all necessary operational positions may safely be reached without the need to use rods or the like. The bars 9 of the telescoping frames 4 may be nestled one inside the next as often as necessary to obtain the smallest possible overall width when in the retracted position. Said bars 9 are positioned outside the frontal boundary of the containers 7, but inside the maximum width of containers.

The “real” personnel cage 3 with all of the control elements is fastend at the bar 9 which can be telescopically extended to the lowest position. Said cage is constructed in such a way that it guarantees the maximum protection for the staff and the optimum of accessibility to the twistlocks. The closed wall may contain the control elements; at the same time it has the function of a sliding surface along the containers 7.

According to the illustrated embodiment each of the personnel cages 3 is provided with its own lifting motor 8 to be operated from the side of the corresponding personnel cage 3. Said lifting motor 8 may be a motor with ropes or a hydraulic motor.

The energy necessary for lifting and lowering the personnel cages 3 is preferably provided as electrical power supplied by means of the spreader 1. On the other hand, it would be possible to provide it in the form of hydraulic power or to accumulate the static and the kinetic energy available when positioning the spreader 1. The accumulation (e.g. storage battery or hydraulic accumulator) of the energy induced into the device has the advantage that said device may be put on a container stack. This enables the staff to operate one after the other in all positions of a stack, independent of the presence of the spreader 1, which in the meantime is free to carry out other loading or unloading operations. In the case of a power supply via the spreader 1 it is advantageous if the connection to the spreader 1 is automatically re-established when it is positioned again. Alternatively, a manual coupling is also possible.

The energy supply for lifting the personnel cage 3 again may be realized as follows:

1. External Energy Supply

1.1. Electric, hydraulic, pneumatic power supply from the spreader 1 to the personnel cage 3 via manual contacting (contact plugs).

1.2. Electric, hydraulic, pneumatic power supply from the spreader 1 to the personnel cage 3 via automatic contacting (plugs) when coupling spreader−personnel cage.

2. Energy Accumulation

2.1. During positioning the spreader 1 on the personnel cage 3, the energy present in the form of weight of spreader×lowering height is stored by means of:

2.1.1. hydraulic cylinders which are compressed by the weight of the spreader, in hydraulic storage medium,

2.1.2. mechanic spring accumulator compressed by the weight of the spreader,

2.1.3. counterweight which is lifted by the weight of the spreader via deflection pulleys for ropes or chains or the like, in such a way as to store energy.

2.2. During repositioning the personnel cage 3 by means of the spreader 1 into the inoperative position the energy present in the form of weight of (spreader+personnel cage)×lowering height by means of:

2.2.1. hydraulic cylinders which are compressed by the weight of the spreader, in hydraulic storage medium,

2.2.2. mechanic spring accumulator compressed by the weight of the spreader,

2.2.3. counterweight which is lifted by the weight of the spreader via deflection pulleys for ropes or chains or the like, in such a way as to store energy.

1. Device for transporting people by a spreader (1), comprising a vertically moveable head beam (10) with horizontally extendable long bars (11), characterized in that a personnel cage (3) for receiving operators is mounted on the free end of at least one long bar (11), said cage being vertically moveable.

2. Device according to claim 1, wherein both long bars (11) carry a personnel cage (3).

3. Device according to claim 2, wherein both personnel cages (3) are interconnected by means of a housing (6) which may be coupled to the head beam (10) of the spreader (1).

4. Device according to claim 3, wherein cantilever beams (5) are mounted in said housing (6), each beam carrying a personnel cage (3).

5. Device according to any of the preceding claims, wherein each of said personnel cages (3) is provided with its own lifting motor (8).

6. Device according to claim 5, wherein said lifting motor (8) may be operated from the inside of the personnel cage (3).

7. Device according to any of the preceding claims, wherein the shifting movements of the personnel cage (3) are coupled with those of the spreader (1).

8. Device according to claim 7, wherein power supply for lifting and lowering the personnel cage (3) is issued from the spreader (1).

9. Device according to any of the claims 1 to 7, wherein the static and kinetic energy present in the spreader (1) when this is put onto its position is used for the lifting motor (8) of the personnel cage (3).

10. Device according to claim 8 or 9, wherein the energy present in the device is stored and may be called for lifting or lowering the personnel cage (3).
